(19) United States
(12) Patent Application Publication
(10) Pub. No.: US 2002/0198293 A1
(43) Pub. Date: Dec. 26, 2002

(54) Ambient dry paints containing finely milled cellulose particles

(76) Inventors: Gary P. Craun, Berea, OH (US); Yucel Tavolara, Strongsville, OH (US)

Correspondence Address: Thomas M. Schmitz, 900 Huntington Bldg., 925 Euclid Ave., Cleveland, OH, 44115, US

(21) Appl. No.: 09/877,445

(22) Filed: Jun. 11, 2001

(51) Int. Cl. C08L 1/00

(52) U.S. Cl. 524/47

(57) ABSTRACT

The invention pertains to aqueous dispersed latex paint comprising film forming polymeric binder with milled cellulose particles less than 100 microns measured by weight volume distribution. The milled cellulose particles are produced by milling together cellulose fibers with mineral extender filler pigment in a size reduction milling operation to produce rather uniform milled cellulose particles preferably having a particle size between 10 and 60 microns. The weight ratio of milled cellulose particles to milled mineral extender pigments (fillers) is between 5/95 to 80/20.

This invention pertains to ambient dry aqueous dispersed paints and more particularly to aqueous emulsion paints containing dispersed finely milled cellulose particles as inert filler material.

### BACKGROUND OF THE INVENTION

Paint coatings are surface protective coatings applied to substrates and dried to form continuous films for decorative purposes as well as to protect the substrate. Consumer paint coatings are air-drying aqueous coatings applied primarily to architectural interior or exterior surfaces, where the coatings are sufficiently fluid to flow out, form a continuous paint film, and dry at ambient temperatures to protect the substrate surface. A paint coating ordinarily comprises an organic polymer binder, pigments, and various paint additives. In dried paint films, the polymeric binder functions as a binder for the pigments and provides adhesion of the dried paint film to the substrate. The pigments may be organic or inorganic and functionally contribute to opacity and color in addition to durability and hardness, although some paint coatings contain little or no opacifying pigments and are described as clear coatings. The manufacture of paint coatings involves the preparation of a polymeric binder, mixing of component materials, grinding of pigments in a dispersant medium, and thinning to commercial standards.

Decorative interior paints are generally composed of (a) pigments, which give opacity and color, (b) vinyl or acrylic latex polymeric film forming binder, which provides film integrity, adhesion, and gloss, (c) thickeners, which provide rheology control for proper application, splatter resistance, and sag resistance, (d) additives, which provide coalescence for film forming, and resistance to biological attack and excessive foaming, and (e) mineral fillers (or extenders), which provide bulk and some opacity. Fillers are commonly low cost inorganic materials such as talcs, clays, calcium carbonate, and the like.

It now has been found that finely milled cellulose particles provide improved bulk and opacity more efficiently than conventional fillers. In accordance with this invention, milled cellulose particles below 100 microns can be produced by milling cellulose fibrous materials such as paper, wood flour, wheat straw, saw dust, hay, cotton linters, and similar cellulose material with an inert inorganic extender such as calcium carbonate, clay, talc or similar paint inorganic extender. The combination of extender pigment and cellulose milled together produces fine cellulose particles which can be utilized in ambient dry paint compositions to replace part or all of the inorganic extender materials in the ambient dry paint composition. In contrast, milling or grinding the cellulose material alone without an inert mineral extender pigment does not produce acceptable milled cellulose particles and in fact imparts detrimental effects on the resulting paint, such as very high viscosity and/or very low volume solids. Cellulose materials milled together with an inert extender in accordance with this invention provide numerous improved paint and dried film integrity properties, such as, higher scrub resistance, toughness, flexibility, very low sheen, good water resistance, along with excellent application properties. The milled cellulose particles provide enhanced interaction with thickeners and flatting agents, where increased levels of milled cellulose particles decrease the level of thickeners required and impart low gloss sheen to dried paint films for desirable eggshell, low lustre and flat paint finishes. The milled cellulose particles appear to reinforce the binder properties and also function as a thickener, and are especially effective in raising high shear paint viscosity, a physical property difficult to achieve with conventional paint thickeners. Milled cellulose material used in decorative paint will significantly reduce the density of paint, which in turn provides a significant reduction in the cost of shipping and handling paint. Milled cellulose is a biorenewable material and similarly biodegradable and non-toxic to people and the environment. These and other advantages will become more apparent by referring to the detailed description of the invention.

### SUMMARY OF THE INVENTION

Briefly, the invention pertains to aqueous emulsion paints containing polymeric film forming binder, milled cellulose particles, and inorganic mineral extender pigment, where the cellulose is milled with the extender pigment to provide cellulose particles having less than about 100 microns volume weight particle size distribution. The paint composition comprises about 1% to 75% volume solids milled cellulose particles. The weight ratio of milled cellulose particles to extender pigment milled together is from about 5/95 to 80/20 to provide micron size cellulose particles in accordance with this invention.

### IN THE DRAWINGS

FIG. 1 is a continuous scanning microphotograph magnified 1000 times of newsblank milled without calcium carbonate;

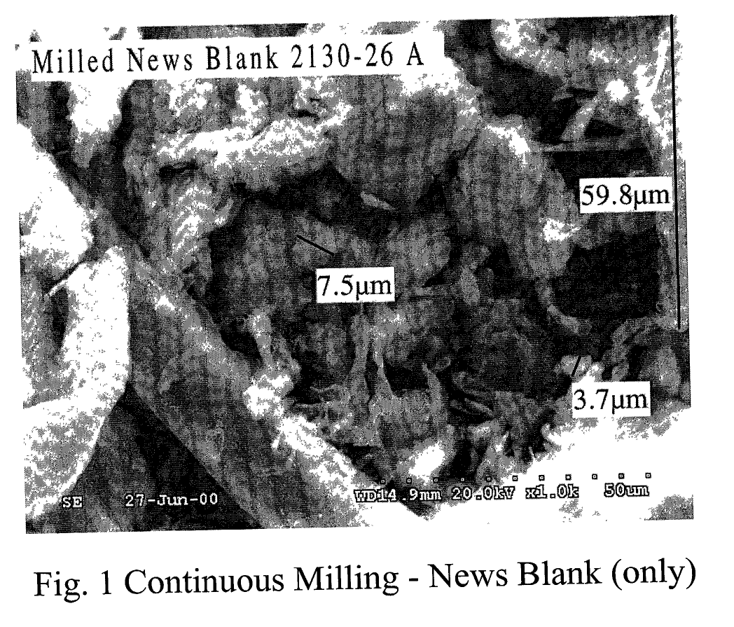

FIG. 2 is a continuous scanning microphotograph magnified 1000 times comparable to FIG. 1, but with newsblank milled with calcium carbonate inert filler;

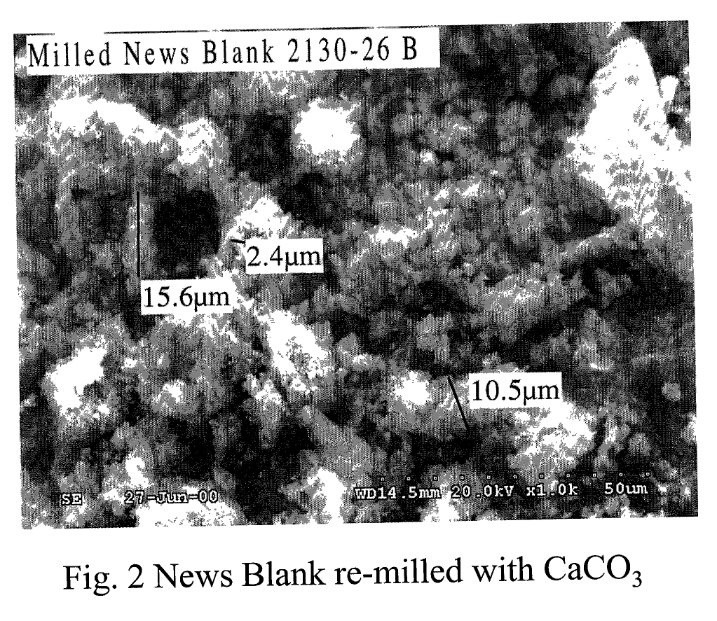

FIG. 3 is a continuous scanning microphotograph comparable to FIG. 1, but magnified 250 times;

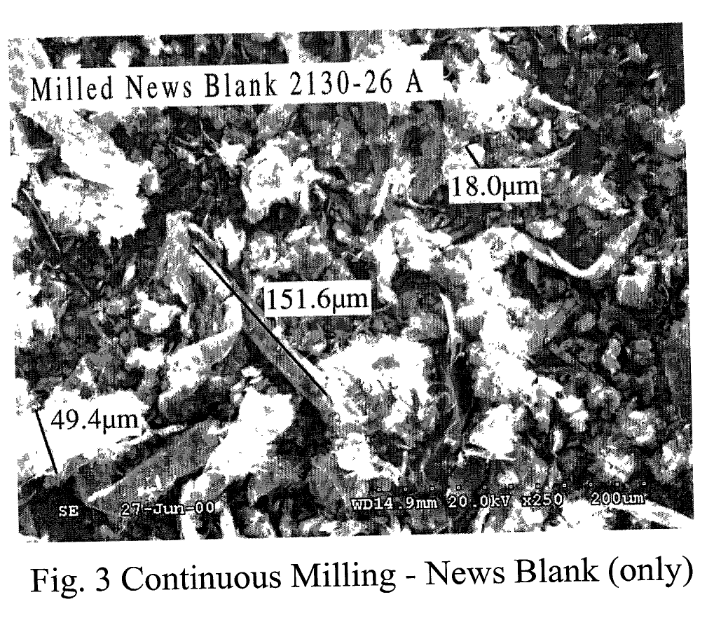

FIG. 4 is a continuous scanning microphotograph comparable to FIG. 2, but magnified 250 times.

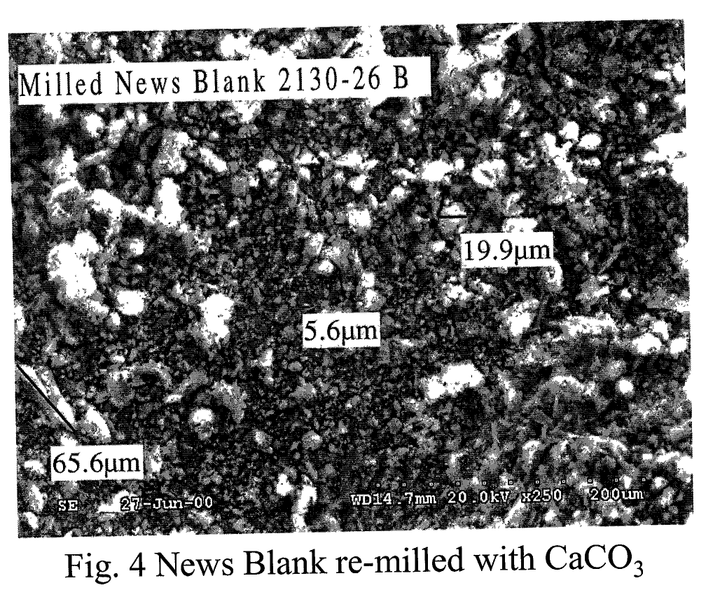

### DETAILED DESCRIPTION OF THE INVENTION

The aqueous dispersed paint of this invention is based on an aqueous emulsion polymeric binder such as latex containing milled cellulose particles in combination with milled extender pigment in conjunction with other ordinary paint compounding ingredients.

Cellulose is a natural growing fiber material of vegetable origin frequently found in land and marine plants including wood, bast, and leafy plants, cotton, and similar plants. Cellulose fibers ordinarily are long fibrous thread structures frequently bound to lignin in the lignocellulose form. Naturally occurring cellulose material ordinarily is chemically treated to remove lignin and produce cellulose fibers useful for industrial uses generally such as pulping for production of paper. Industrially useful fibers are textile fibers, bast or stem fibers such as flax, jute, hemp, and ramie, leaf fibers such as sisal or abaca fibers, seed and fruit fibers such as cotton and kapok, and non-textile fibers from hardwoods and softwoods, where the dominant component is cellulose. The intent of this invention is to utilize scrap waste or recycled industrial cellulose fiber products such as scrap trimmings from paper products, scrap or recycled newsprint, where non-printed white newspaper conventionally called newspaper blank, is preferred. Scrap wood flour, wheat straw, saw dust, cotton linters, and similar recovered scrap products are likewise desirable sources of cellulose materials. The recovered scrap cellulose products ordinarily are in fibrous form in the recovered scrap and then milled with a mineral paint extender pigment to provide milled particle size cellulose particles less than 100 microns, and preferably between 10 and 60 microns, measured by volume weight distribution.

In accordance with this invention, scrap cellulose products are combined with an inorganic extender mineral such as clay, talc, or calcium carbonate and milled to a fine particle size less than about 100 microns. The milling of cellulose fibers together with mineral extender effectively mills the cellulose fibers into cellulose particles. Inorganic extender mineral pigments commonly used in paint products and useful in this invention, are light colored or white having a low refractive index between about 1.4 to 1.7, which frequently become transparent or colorless when fully whetted with polymeric binder. Useful inorganic extender pigments include calcium carbonate; aluminum silicates such as China clay, Kaolin clay, and calcined clay; magnesium silicates such as talc or abestine; barium sulphate such as barytes; and silica mineral particles. Typical particle sizes for mineral extender pigments are between about 0.5 to 25 microns. The weight ration of cellulose to extender pigment used in the milling process of this invention is between about 5/95 and 80/20, and preferably between 40/60 and 80/20. The paint composition of this invention contains from about 1% to 75% and preferably between 5% and 60%, by volume milled cellulose particles.

In accordance with this invention, an extender pigment is combined with cellulose fibrous products and preferably milled in a media mill. A media mill is a mill similar to a ball mill but tumbled at much higher speeds. The cellulose scrap and extender pigment mixture is ground sufficiently to obtain cellulose particles less than 100 microns, and preferably between 10 microns and 60 microns, measured by weight volume distribution. Milling scrap or recycled cellulose fibers in accordance with this invention transforms the elongated fibrous cellulose into comparable dimension particles. For instance, cellulose fibers typically can be about 30 microns diameter with a fiber length of several hundred to one thousand microns long. Milled cellulose particles in accordance with this invention are typically between 10 and 60 microns diameter and less than 100 microns length. Ordinarily, the milled cellulose particle length is less than 2.5 the diameter dimension, and preferably the particle length is less than twice the particle diameter.

Milled particles enable considerably higher loading of the paint without excessive viscosity increases. The grinding media in the media mill for grinding can be ceramic or steel balls, cones, rods, beads, and other small grinding configurations typically about 2 to 20 mm microns in size, which impact each other in a high energy impacting frequency and speed to obtain the desired particle size milled cellulose particles. It has been found that cellulose waste or scrap products not ground with an extender pigment will not work due to the cellulose being undesirably too high in particle size and acicular fibrous structure. For instance, scrap paper milled alone without extender pigment produced high fractions of milled paper having fiber lengths above about 100 microns or more in particle size non-uniform fibrous structure. Similarly, milled cellulose particles alone subsequently mixed with an extender pigment to produce an admixture of preformed materials likewise produced an unacceptable paint. The long fibrous structure milled without extender pigment cause very high paint viscosity with very low loading volume solids (low loading), poor application properties, and otherwise produces an unacceptable paint product.

Although not completely understood, an unexpected advantage is obtained by milling the cellulose fibrous scrap or waste with extender pigment, where the combination is believed to assist milling cellulose to a finer particle size, especially short length particles, due to grinding action of the extender pigment. The milled cellulose simultaneously seems to coat the extender pigment due the intimate grinding together of cellulose and extender pigment. By milling cellulose fibers with extender pigments, the cellulose fibers are milled to become smaller and more uniform in particle size, especially shorter length particles comparable to the diameter dimension. The milled cellulose particles of this invention provide inert filler or extender material for the paint, but also exhibits co-binder properties with a latex polymeric binder. Using cellulose milled to a fine size with extender pigment has been found to substantially improve the quality of paint, including improved scrub resistance, toughness, flexibility, water resistance, excellent application properties, as well as low sheen, excellent thickener and flatting characteristics. The milled cellulose particles assist paint thickening and enables latex paints to be made at sharply reduced levels of thickener or even without conventional thickeners. The milled cellulose particles of this invention can be added to paint at volume solids up to 30% or higher and is especially effective in raising high shear and paint viscosity properties, which are properties difficult to achieve without normal levels of conventional thickeners.

In a preferred aspect of this invention, cellulose fibrous material, such as newsblank, is first cut to small size on the order of one-quarter inch pieces. The cut, or otherwise chopped, precut pieces are then subjected to a grinding action to reduce the size of the small fibers and to separate and tear fibers apart. A hammer mill grinding media is particularly useful to maintain whiteness of the ground cellulose fibers. Some fibers at this point are ground small particles but most remain fibrous in structure. The ground fibers are then milled with an inert mineral extender (filler) in accordance with this invention.

Referring now to the matrix copolymer, the matrix polymeric binder comprises an aqueous emulsion copolymerized ethylenically unsaturated monomers to produce a binder copolymer. Useful ethylenically unsaturated monomers include vinyl and acrylic monomers or combinations thereof. Polymerizable ethylenically unsaturated monomers contain carbon-to-carbon unsaturation and include vinyl monomers, acrylic monomers, allylic monomers, acrylamide monomers, and mono- and dicarboxylic unsaturated acids. Vinyl esters include vinyl propionate, vinyl laurate, vinyl decanoate, vinyl butyrates, vinyl benzoates, vinyl isopropyl acetates and similar vinyl esters; vinyl aliphatic hydrocarbon monomers include vinyl chloride and vinylidene chloride as well as alpha olefins such as ethylene, propylene, isobutylene, as well as conjugated dienes such as 1,3 butadiene, methyl-2-butadiene, 1,3-piperylene, 2,3-dimethyl butadiene, isoprene, cyclohexane, cyclopentadiene, and dicyclopentadiene; and vinyl either. The vinyl acetate monomer is polymerized to produce a polymeric binder comprising emulsion polymerized vinyl acetate. Selected amounts of other ethylenic monomers can be copolymerized with the vinyl acetate monomer to produce a copolymer containing by weight less than 60% and preferably less than 30% and most preferably less than 20% other ethylenic monomer. Acrylic monomers include lower alkyl esters of acrylic or methacrylic acid having an alkyl ester portion containing between 1 to 12 carbon atoms as well as aromatic derivatives of acrylic and methacrylic acid. Useful acrylic monomers include, for example, acrylic and methacrylic acid, methyl acrylate and methacrylate, ethyl acrylate and methacrylate, butyl acrylate and methacrylate, propyl acrylate and methacrylate, 2-ethyl hexyl acrylate and methacryate, cyclohexyl acrylate and methacrylate, decyl acrylate and methacrylate, isodecyl acrylate and methacrylate benzyl acrylate and methacylate, and various reaction products such as butyl, phenyl, and cresyl glycidyl ethers reacted with acrylic and methacrylic acids, hydroxyl alkyl acrylates and methacrylates such as hydroxyethyl and hydroxpropyl acrylates and methacrylates, amino acrylates, methacrylates as well as acrylic acids such as acrylic and methacrylic acid, ethacrylic acid, alpha-chloroacrylic acid, crotonic acid, beta-acryloxy propionic acid, and beta-styrl acrylic acid. Particularly preferred comonomers include acrylates such as methyl, ethyl, propyl, butyl (linear and branched), 2-ethyl hexyl; methacrylates such as methyl, ethyl, propyl, butyl (linear and branced), 2-ethyl hexyl; vinyl esters such as acetate, proprionate, butyrate, pentanoate (neo 5), nonanoate (neo 9), 2-ethyl hexanoate, decanoate (neo 10); and other ethylenic monomers such as ethylene, vinyl chloride, vinylidene chloride and butadiene.

The organic monomer mixture may further contain a free radical initiator and is then suspended in water containing surfactant. The vinyl or acrylate or vinyl/acrylate mixtures of monomer and other ethylenic monomer are polymerized in an aqueous polymerization medium by adding other emulsion polymerization ingredients. Initiators can include for example, typical free radical and redox types such as hydrogen peroxide, t-butyl hydroperoxide, di-t-butyl peroxide, benzoyl peroxide, benzoyl hydroperoxide, 2,4-dichlorobenzoyl peroxide, t-butyl peracetate, azobisisobutyronitrile, ammonium persulfate, sodium persulfate, potassium persulfate, sodium perphosphate, potassium perphosphate, isopropyl peroxycarbonate, and redox initiators such as sodium persulfate-sodium formaldehyde sulfoxylate, cumene hydroperoxide-sodium metaisulfite, potassium persulfate-sodium bisulfite, cumene hydroperoxide-iron (II) sulfate. Redox systems consist of oxidants and reductants, which can be mixed in any pair. Transition metals such as iron can be used as accelerators for initiators for redox couples. The polymerization initiators are usually added in amounts between about 0.1 to 2 weight percent.

Suitable anionic surfactants include for example, salts of fatty acids such as sodium and potassium salts of stearic, palmetic, oleic, lauric, and tall oil acids, slats of sulfated fatty alcohols, salts of phosphoric acid esters of polyethylated long chain alcohols and phenols. Preferred anionic surfactants include for example, alkylbenzene sulfonate salts such as sodium dodecylbenzene sulfonate and salts of hexyl, octyl, and higher alkyl diesters of 2-sulfosuccinic acid. Suitable non-ionic surfactants include polyoxyethylene glycols reacted with lyophilic compound, ethylene oxide condensation products reacted with t-octylphenol or nonylphenol and known as “Triton” surfactants, polymerized oxyethylene (IgepalCA), ethylene oxide reacted with organic acids (Emulfor), or organic acid reacted with polyoxyamylene either of stearic or oleic acid esters (Tweens). Suitable surfactants include the various sulfosuccinates such as hexyl, octyl, and hexadecyl sulfosuccinate, the various alkyl and alkyl-aromatic sulfates and sulfonates, as can be generally formed at

The suspension can be heated to polymerize the vinyl and/or acrylic monomers while initiator is added if not already present in the pre-emulsion mixture. Suitable initiators include the common persulfates, peroxides, and hydroperoxides, along with redox initiator systems if desired. Additional monomers can be added at any time during the polymerization to increase the particle size and raise the total solids of the system and help control the polymerization exotherm.

A paint coating composition can be produced by combining the latex emulsion matrix binder with the combination of milled cellulose particles and extender pigment in accordance with this invention along with opacifying pigments and other paint additives in a dispersing mill such as a Cowlese disperser. A pigment dispersion can be preformed consisting of a dispersant and pigments on a disperser mill, a sand mill, a pebble mill, a roller mill, a ball mill or similar conventional grinding mill for milling the mineral pigments into the dispersion medium. The premix can then be combined under low shear with the polymeric binder of this invention and other paint additives as desired. Useful opacifying pigments are titanium dioxide, zinc oxide, titanium calcium, as well as tinting pigments such as carbon black, yellow oxides, brown oxides, tan oxides, raw and burnt sienna or umber, chromium oxide green, phthalocyanine green, phthalonitrile blue, ultramarine blue, cadmium pigments, chromium pigments, and the like. Filler pigments such as clay, silica, talc, mica, wollastonite, wood flower, barium sulfate, calcium carbonate and the like can be added. The resulting paints can be used as an interior or exterior architectural maintenance paint.

The merits of this invention are further supported by the following illustrative examples.

### EXAMPLE 1

Milled Cellulose

Paints of this invention were made using milled cellulose with CaCO₃ and milled cellulose with clay. Newspaper blank (newspaper without ink) was shredded to about ¼ by ¼ inch square shreds. About 1,000 grams shredded paper was ground in a Union Process HAS-1 mill with 2.2-2.5 mm zirconium silicate bead grinding media at 1,500 rpm and 0.8 micron discharge screen. The milled paper was then mixed in a 50:50 weight ratio with 11 micron CaCO₃ or calcined clay and then re-milled under the same conditions. Particle sizes were measured with a Model 770 AccuSizer. The number weight distribution and volume weight distribution or the resulting ground mixture of cellulose and calcium carbonate particles are listed in the following Tables 1 and 2.

Office copier paper was milled under the same conditions alone, and then in a 50:50 weight ratio with CaCO₃. They were used as milled cellulose in standard commercial paint formulas in accordance with this invention in Examples 2-4. Milled cellulose versions of conventional, commercial satin and flat paint compositions were formulated which are superior to the control standard flat and egg shell finish paints without milled cellulose for scrub resistance. The satin and the flat paints of this invention required only 4% to 45% of the HASE thickeners of what the controls required in order the bring the stormer viscosities up the 85-90 ku's.

Gloss and sheen of the milled cellulose paints were 26-50% lower than the control without milled cellulose.

TABLE 1
Volume Weight Differential Distribution

| | | | Newsblank re-milled |
|---|---|---|---|
| Diameter in microns | Milled newsblank | CaCO₃ | with CaCO₃ |
| <2 | <1% | 5% | 2% |
| 2-5 | 2% | 10% | 8% |
| 5-10 | 8% | 30% | 20% |
| 10-20 | 20% | 40% | 35% |
| 20-50 | 30% | 15% | 30% |
| 50-100 | 20% | None | 5% |
| >100 | 20% | None | None |

TABLE 2
Number Weight Differential Distribution

| | | | Newsblank re-milled |
|---|---|---|---|
| Diameter in microns | Milled newsblank | CaCO₃ | with CaCO₃ |
| 0-1 | 35 | 50 | 70 |
| 1-2 | 20 | 25 | 20 |
| 2-5 | 20 | 18 | 6 |
| 5-10 | 10 | 5 | 3 |
| 10-20 | 10 | 2 | 1 |
| 20-50 | 4 | <1 | <1 |
| >50 | 1 | None | None |

These paints were superior to standard commercial control paints without milled cellulose for scrubs and less HASE thickener use. The resulting paints have excellent application characteristics. Paint films produced from these paints containing milled cellulose are very tough but still have excellent flexibility.

### EXAMPLE 2

| Milled Cellulose Formula - Flat Paint | | |
|---|---|---|
| Water | 430.00 | lbs. |
| In-can Preservative | 1.20 | lbs. |
| Defoamer | 1.72 | lbs. |
| Pigment Dispersant | 22.36 | lbs. |
| Nonionic surfactant | 4.82 | lbs. |
| In the above mix, disperse under high sheer | | |
| Milled Cellulose/CaCO₃ from Example 1 | 240.00 | lbs. |
| Titanium Dioxide | 112.00 | lbs. |
| Letdown | | |
| Resin | 191.00 | lbs. |
| Coalescing Agent | 21.00 | lbs. |
| Defoamer | 3.00 | lbs. |
| Ammonium hydroxide (19%) | 2.00 | lbs. |
| HASE thickener | 1.00 | lbs. |

### EXAMPLE 3

Milled Cellulose—Egg Shell Paint

Comparative paints were made by replacing the clay in the standard commercial control paint formula to include milled cellulose/clay combination. Testing showed better scrub resistant and lower gloss and sheen compared to Control.

Milled Cellulose - Egg Shell Paint

| | | |
|---|---|---|
| Water | 113.0 | lbs. |
| In-can Preservative | 2.00 | lbs. |
| Defoamer | 2.00 | lbs. |
| Pigment Dispersant | 5.00 | lbs. |
| Non-ionic surfactant | 6.00 | lbs. |

In above mix, disperse under high sheer the following materials.

| | | |
|---|---|---|
| Milled Cellulose/clay from Example 1 | 33.00 | lbs. |
| Titanium Dioxide | 157.00 | lbs. |
| Let down | | |
| Water | 218.00 | lbs. |
| Resin | 320.00 | lbs. |
| Coalescing Agent | 53.00 | lbs. |
| Defoamer | 3.00 | lbs. |
| Ammonium hydroxide (19%) | 2.00 | lbs. |
| OP 96 | 69.00 | lbs. |
| HASE thickener | 5.00 | lbs. |
| HASE thickener | 5.00 | lbs. |

### EXAMPLE 4

Milled Cellulose—Flat Paint

Paint of this invention was made by replacing the clay in the standard control formula to produce milled cellulose/clay paint composition. This paint has excellent water resistance and scrub resistance when compared to the Control. Sheen was lower than 0.8 while control was 5.1 and only half of the HASE thickener was used to reach 93 ku stormer viscosity. The paint had very good brushability and excellent spray properties.

| Milled cellulose - Flat Paint | | |
|---|---|---|
| Water | 251.25 | lbs. |
| Ammonium hydroxide (19%) | 2.00 | lbs. |
| HASE thickener | 3.00 | lbs. |
| In-can Preservative | 2.00 | lbs. |
| Pigment Dispersant | 1.00 | lbs. |
| Defoamer | 1.00 | lbs. |
| Non-ionic surfactant | 3.00 | lbs. |
| In above mix, disperse under high sheer | | |
| Titanium Dioxide | 50.00 | lbs. |
| Milled Cellulose/clay from Example 1 | 142.00 | lbs. |
| Letdown | | |
| Water | 396.15 | lbs. |
| Defoamer | 2.00 | |
| Resin | 48.00 | lbs. |
| HASE thickener | 29.50 | lbs. |
| Ammonium hydroxide | 4.50 | lbs. |
| Non-ionic surfactant | 2.00 | lbs. |
| Coalescent | 4.00 | lbs. |

### Test Format

Gloss:

Gloss measurements were made BYK-Gardner micro-TRI-gloss glossmeter.

Shim Scrub Test and Procedure:

Scrub resistance test was made according to ASTM test method 2486.

1. Make a 3 mil drawdown widthwise, using the 9 inch drawdown blade, on a Leneta black plastic scrub chart of a teat paint versus a standard.

2. Allow panels to air dry for 7 days.

3. A glass plate, with two ½ inch wide, 10 mil thick shim strips glued perpendicular to the length of the glass plate, is placed in the scrub machine pan.

4. The test panel then is placed on this glass plate in pan. The shim strips under the panel should be in the approximate middle of each test film.

5. Weight 10 grams of abrasive scrub medium on the bottom of the brush, place the brush in holder and attach the scrub machine.

6. Add 5 cc of water to panel in path of scrub brush and start the scrub machine.

7. Record the number of cycles need to remove the film in a single line across the ½ inch width of the shim.

TABLE 3

| | |
|---|---|
| Shim Scrub Results: | |
| Milled Cellulose Paint - Example 2 | 400-540 cycles |
| Control | 150-260 cycles |
| Milled Cellulose Paint - Example 3 | 1850-260 cycles |
| Control | 1200-1450 cycles |
| Milled Cellulose Paint - Example 4 | 19-24 cycles |
| Control | 7-9 cycles |
| Sheen/Gloss Results: | |
| Milled Cellulose Paint - Example 2 | 2.6 @ 60 and 1.8 @ 85 |
| Control | 2.2 @ 60 and 5.1 @ 85 |
| Milled Cellulose Paint - Example 3 | 17 @ 60 and 33 @ 85 |
| Control | 26 @ 60 and 69 @ 85 |
| Milled Cellulose Paint - Example 4 | 1.9 @ 60 and 85 @ 0.8 |
| Control | 2.5 @ 60 and 5.1 @ 85 |

### EXAMPLE 5

Hard white recycled paper (ink-free) from Combined Resources was ground in a Schutte Series #1320 hammer mill at 3600 rpm with a ⅛ inch screen. Microscopic evaluation of the white, fluffy, cotton-like ground product showed the cellulose fibers to be several hundred microns long. The ground paper was blended with 11 micron CaCO₃ in 75/25, 50/50, and 25/75 weight ratios. The three blends were then milled in a Union Process HAS-1 mill with 2.2-2.5 mm zirconium silicate bead grinding media as above. Particle size as measured by the Model 770 AccuSizer was as follows:

TABLE 4

| CaCO₃ to Paper weight ratio | Volume weighted mean particle size |
|---|---|
| 25/75 | 41.8 microns |
| 50/50 | 33.0 microns |
| 75/25 | 21.5 microns |

These results indicate the important effect that the extender has in acting as a grinding aid. Higher extender to paper ratios give a smaller particle size when milled together under identical conditions.

The merits of this invention are described and illustrated above but are not intended to be limiting in scope, except by the appended claims.

1. An aqueous emulsion ambient dry paint coating composition containing a film forming polymeric binder, opacifying pigment, the paint comprising:
a polymeric film forming binder of aqueous polymerized ethylenically unsaturated monomers;
between 1% and 75% volume solids of milled cellulose particles;
milled mineral extender filler pigment;
where the weight ratio of milled cellulose particles to milled extender filler pigment is between 5/95 and 80/20, and cellulose fibers and extender filler pigment are combined and milled together for sufficient time to produce the milled cellulose particles and milled extender filler pigment, where the particle size of milled cellulose particles is less than 100 microns measure by weight volume distribution.

2. The paint composition of claim 1 where the particle size of milled particles is from 10 microns to 60 microns weight volume distribution.

3. The paint composition of claim 1 where the milled cellulose particles have comparable length and diameter dimensions.

4. The paint composition of claim 1 where the length of the milled cellulose particles is less than 2.5 times the cellulose particles diameter.

5. The paint composition of claim 1 where the weight ratio of milled cellulose particles to milled mineral extender pigment is between 40/60 and 80/20.

6. The paint composition of claim 1 where the volume solids of milled cellulose particles from 5 vol percent to 60 vol percent.
